(19) United States
(12) Patent Application Publication
(10) Pub. No.: US 2008/0030608 A1
(43) Pub. Date: Feb. 7, 2008

(54) Electronic camera and combined program

(75) Inventors: Kazutaka Yoshizawa, Akiruno-shi (JP); Yasushi Handa, Kobe-shi (JP); Susumu Nozaki, Katano-shi (JP); Masao Imoto, Daito-shi (JP)

Correspondence Address: BODNER & O'ROURKE, LLP, 425 BROADHOLLOW ROAD, SUITE 108, MELVILLE, NY, 11747, US

(73) Assignee: SANYO Electric Co., Ltd., Moriguchi-shi (JP)

(21) Appl. No.: 11/827,340

(22) Filed: Jul. 11, 2007

(30) Foreign Application Priority Data
Aug. 7, 2006 (JP) 2006-213996

(51) Int. Cl. H04N 5/222

(52) U.S. Cl. 348/333.01; 348/E05.022

(57) ABSTRACT

An electronic camera includes an imager capturing an object scene. When a shutter button is operated in a camera mode, a CPU records image data representative of the object scene captured by the imager in a memory card. The CPU further-notifies support information describing a processable resolution to an external PC under a USB capturing mode. When the shutter button is operated under the USB capturing mode, shutter button information representative of “on state” is output to the external PC. The CPU further inputs image data sent back from the external PC in response to the shutter button information representative of “on state”. The input image data is recorded in the memory card by the CPU.

### CROSS REFERENCE OF RELATED APPLICATION

The disclosure of Japanese Patent Application No. 2006-213996 is incorporated herein by reference.

### BACKGROUND OF THE INVENTION

1. Field of the Invention

The present invention relates to electronic cameras. More specifically, the present invention relates to an electronic camera fetching a desired image data from an external apparatus.

The present invention also relates to a combined program. More specifically, the present invention relates to a combined program controlling a data transfer from one apparatus to the other apparatus.

2. Description of the Related Art

One example of a camera of this kind is disclosed in a Patent Document 1 (Japanese Patent Application Laid-Open No. 2006-99660). According to the related art, a digital camera is placed on a cradle connected to a PC. Image data stored in the PC is transferred to the digital camera via the cradle, and an image on the basis of the transferred image data is displayed on a display portion of the digital camera. When a storing instruction is issued in a state that a desired image is displayed, image data of the display image is recorded in the memory card.

However, in the related art, the data transfer from the PC to the digital camera is executed prior to a storing instruction. This causes useless data transfer processing regardless of recording to the memory card.

### SUMMARY OF THE INVENTION

Therefore, it is a primary object of the present invention to provide a novel electronic camera.

Another object of the present invention is to provide an electronic camera capable of recording image data under the control of an external apparatus in a recording medium.

The other object of the present invention is to provide a novel combined program.

A further object of the present invention is to provide a combined program capable of recording data under the control of a data transfer apparatus in a recording medium of a data fetching apparatus.

An electronic camera comprises an imager for capturing an object scene; a first recorder for recording image data representative of the object scene captured by the imager in a recording medium when a first fetching operation is executed under a first fetching mode; an outputter for outputting fetching operation information to an external apparatus when a second fetching operation is executed under a second fetching mode; an inputter for inputting image data sent back from the external apparatus in response to the fetching operation information output by the outputter; and a second recorder for recording the image data input by the inputter in the recording medium.

An object scene is captured by an imager. A first recorder records image data representative of the object scene captured by the imager in a recording medium when a first fetching operation is executed under a first fetching mode. When a second fetching operation is executed under a second fetching mode, fetching operation information is output to an external apparatus by an outputter. An inputter inputs image data sent back from the external apparatus in response to the fetching operation information output by the outputter. The image data input by the inputter is recorded in the recording medium by a second recorder.

Accordingly, when a first fetching operation is executed with the first fetching mode selected, the image data of the object scene captured by the imager is recorded, and when a second fetching operation is executed by selecting the second fetching mode, image data under the control of the external apparatus is recorded. Thus, it becomes possible to record the image data under the control of the external apparatus in the recording medium.

It is preferable that the electronic camera according to this invention further comprises a resolution notifier for notifying the external apparatus of resolution information representative of a processable resolution under the second fetching mode. Thus, the external apparatus can output the image data being compliant with resolution information to the electronic camera.

It is further preferable that the image data input by the inputter is image data being compliant with the resolution information notified by the resolution notifier.

In one aspect, the external apparatus comprises an image displaying apparatus, and at least a part of the image data input by the inputter represents at least a part of a display image by the image displaying apparatus. The operator can execute the second fetching operation with reference to the display image, capable of improving operability.

Preferably, the electronic camera according to this invention further comprises a displayer for displaying an image on the basis of the image data recorded by the second recorder. This improves operability.

In one aspect, the resolution notifier executes notifying processing in response to the resolution information request from the external apparatus. In response to the resolution request from the external apparatus, it can be determined that the connection destination is an apparatus capable of receiving a resolution request, that is, being an appropriate apparatus. Thus, it is possible to do away with the need for confirming the resolution of the image data input from the external apparatus.

It is preferable that the electronic camera according to this invention further comprises a mode notifier for notifying the external apparatus of mode information representative of the second fetching mode when a mode information request is received from the external apparatus under the second fetching mode. In response to the mode information request from the external apparatus, it can be determined that the connection destination is an apparatus capable of receiving a mode information request, that is, being an appropriate apparatus. Thus, it is possible to do away with the need for confirming the resolution of the image data input from the external apparatus.

In one aspect, the image data recorded by the first recorder adopts a specific format, and the electronic camera further comprises a converter for converting a format of the image data input by the inputter into the specific format prior to record processing by the second recorder. Thus, it is possible to make it easy to mange the image data recorded in the recording medium.

It is preferable that the outputter executes output processing after notifying processing by the resolution notifier.

In one aspect, the electronic camera further comprises an acceptance key for accepting the first fetching operation under the first fetching mode and accepting the second fetching operation under the second fetching mode. The image under the control of the external apparatus is captured in the operation the same as the operation of the capturing operation of the object scene image.

According to the present invention, an image data processing program executed by a processor of an electronic camera provided with an imager for capturing an object scene, comprising: a first record step for recording image data representative of the object scene captured by the imager in a recording medium when a first fetching operation is executed under a first fetching mode; an output step for outputting fetching operation information to an external apparatus when a second fetching operation is executed under a second fetching mode; an input step for inputting image data sent back from the external apparatus in response to the fetching operation information output by said output step; and a second record step for recording the image data input by said input step in the recording medium.

As described above, it is possible to record the image data under the control of the external apparatus in the recording medium.

According to the present invention, an image data processing method executed by a processor of an electronic camera provided with an imager for capturing an object scene, comprises: a first record step for recording image data representative of the object scene captured by the imager in a recording medium when a first fetching operation is executed under a first fetching mode; an output step for outputting fetching, operation information to an external apparatus when a second fetching operation is executed under a second fetching mode; an input step for inputting image data sent back from the external apparatus in response to the fetching operation information output by the output step; and a second record step for recording the image data input by the input step in the recording medium.

As described above, it is possible to record the image data under the control of the external apparatus in the recording medium.

A combined program according to the present invention is a combined program having a data fetching program executed by a processor of a data fetching apparatus and a data transferring program executed by a processor of a data transfer apparatus, and the data fetching program comprises: a first output step for outputting fetching operation information to said data transfer apparatus when a fetching operation is executed; a first input step for inputting data sent back from the data transfer apparatus in response to the fetching operation information output by the first output step; and a record step for recording the data input by the first input step in a recording medium, and the data transfer program comprises: a second input step for inputting the fetching operation information output from the data fetching apparatus; and a second output step for outputting the data to the data fetching apparatus in response to the fetching operation information input by the second input step.

A processor of the data fetching apparatus outputs fetching operation information to the data transfer apparatus in a first output step when a fetching operation is executed. The data sent back from the data transfer apparatus in response to the fetching operation information output by the first output step is input in a first input step. The input data by the first input step is recorded in the recording medium by a record step. Furthermore, the processor of the data transfer apparatus inputs the fetching operation information output from the data fetching apparatus in a second input step. The data outputs is output to the data fetching apparatus in response to the fetching operation information input by the second input step in a second output step.

Thus, the fetching operation information and the data are sent and received between the data fetching apparatus and the data transfer apparatus. This makes it possible to record the data under the control of the data transfer apparatus in the recording medium of the data fetching apparatus.

It is preferable that the data fetching program further comprises a specification notifying step for notifying the data transfer apparatus of specification information defining a processable specification, and the data transferring program further comprises a first conversion step for converting the data so as to be compliant with the specification information notified by the specification notifying step. The data transfer apparatus can output the data being compliant with the specification of the data fetching apparatus to the data fetching apparatus.

In addition it is preferable that the data fetching program further comprises a second conversion step for converting a specification of the data input by the first input step into a specific specification prior to the record step.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of one embodiment of the present invention;

FIG. 2 is a block diagram showing one example of a personal computer to be connected with a digital camera shown in FIG. 1;

FIG. 3 is an illustrative view showing one example of an assigned state of a display area to a video memory applied to FIG. 2 embodiment;

FIG. 4 is an appearance view showing one example of a connected state between the digital camera shown in FIG. 1 and the personal computer shown in FIG. 2;

FIG. 5 is an illustrative view showing one example of the exchange of information or data between the digital camera shown in FIG. 1 and the personal computer shown in FIG. 2;

FIG. 6 is a flowchart showing a part of an operation of the digital camera shown in FIG. 1;

FIG. 7 is a flowchart showing another part of the operation of the digital camera shown in FIG. 1;

FIG. 8 is a flowchart showing the other part of the operation of the digital camera shown in FIG. 1;

FIG. 9 is a flowchart showing a part of an operation of the personal computer shown in FIG. 2;

FIG. 10 is a flowchart showing another part of the operation of the personal computer shown in FIG. 2;

FIG. 11 is a flowchart showing the other part of the operation of the personal computer shown in FIG. 2; and

FIG. 12 is an illustrative view showing a part of an operation in another embodiment.

### DETAILED DESCRIPTION OF THE PREFERRED EMBODIMENTS

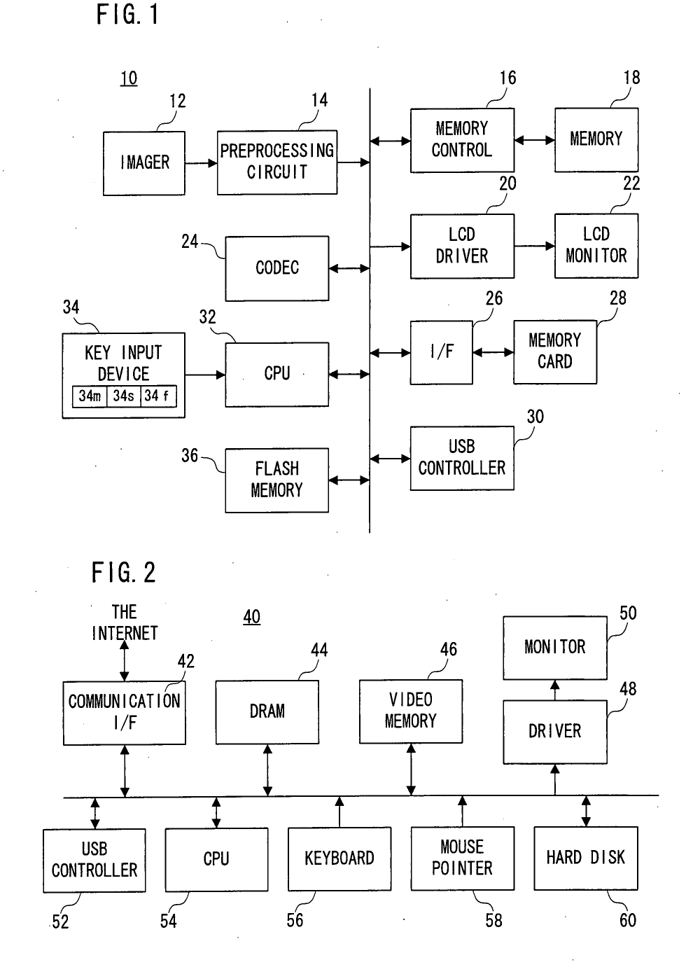

Referring to FIG. 1, a digital camera (electronic camera) 10 of this embodiment includes a key input device 34. When a camera mode is selected by a mode change switch 34m provided to a key input device 34, a CPU 32 instructs an imager 12 to repeatedly perform pre-exposure processing, and instructs an LCD driver 20 to perform through-image display processing in order to execute through image processing.

The imager 12 repeatedly creates low-resolution raw image data corresponding to an optical image of an object scene. The created raw image data is subjected to a color separation, a white balance adjustment, a YUV conversion, etc. by a preprocessing circuit 14, and whereby image data in a YUV format is created. The created image data is written to a memory 18 through a memory control circuit 16. The LCD driver 20 reads the image data stored in the memory 18 through the memory control circuit 16, and drives an LCD monitor 22 on the basis of the read image data. Thus, a real-time motion image (through-image) representing an object scene is displayed on the monitor screen.

When a shutter button 34s provided to the key input device 34 is operated in a state that a camera mode is selected, the CPU 32 instructs the imager 12 to perform primary exposure processing, instructs the LCD driver 20 to perform freeze image displaying processing, instructs a codec 24 to perform compression processing, and instructs an I/F 26 to perform record processing.

The imager 12 creates one frame of high-resolution raw image data corresponding to the optical image of the object scene. The created raw image data is converted into image data in a YUV format by the preprocessing circuit 14, and the converted image data is written to the memory 18 through the memory control circuit 16. The LCD driver 20 repeatedly reads the image data stored in the memory 18 through the memory control circuit 16, performs resolution reducing processing on the read image data, and drives the LCD monitor 22 on the basis of the image data having a reduced resolution. Thus, a still image (freeze image) at a time when the shutter button 34s is operated is displayed on the monitor screen.

The codec 24 reads the image data stored in the memory 18 through the memory control circuit 20, and compresses the read image data to create compressed image data satisfying an EXIF format. The created compressed image data is written to the memory 18 through the memory control circuit 16. The I/F 26 reads the compressed image data stored in the memory 18 through the memory control circuit 16, and records the EXIF file including the read compressed image data in the memory card 28.

When a reproduction mode is selected by the mode change switch 34m, and a desired EXIF file recorded in the memory card 28 is selected by a file selection key 34f provided to the key input device 34, the CPU 32 instructs the I/F 26 to perform reproduction processing, instructs the codec 24 to perform expansion processing, and instructs the LCD driver 20 to perform reproduced image displaying processing.

The I/F 26 reads the compressed image data stored in the desired EXIF file from the memory card 28, and writes the read compressed image data to the memory 18 through the memory control circuit 16. The codec 24 reads the compressed image data stored in the memory 18 through the memory control circuit 16, expands the read compressed image data, and writes the expanded image data to the memory 18 through the memory control circuit 16. The LCD driver 20 reads the image data stored in the memory 18 through the memory control circuit 16, performs resolution reducing processing on the read image data, and drives the LCD monitor 22 on the basis of the image data having the reduced resolution. Thus, a reproduced image is displayed on the monitor screen.

With reference to FIG. 2, a personal computer (hereinafter referred to as “PC”) 40 includes a keyboard 56 and a mouse pointer 58. When a connecting operation with the Internet is performed by the keyboard 56 and/or the mouse pointer 58, a CPU 54 instructs a communication I/F 42 to perform a connection to the Internet to make an access to a designated URL. Thus, image data of the designated URL is fetched through the communication I/F 42. The fetched image data is written to a DRAM 44 by the CPU 54 and then developed in a video memory 46.

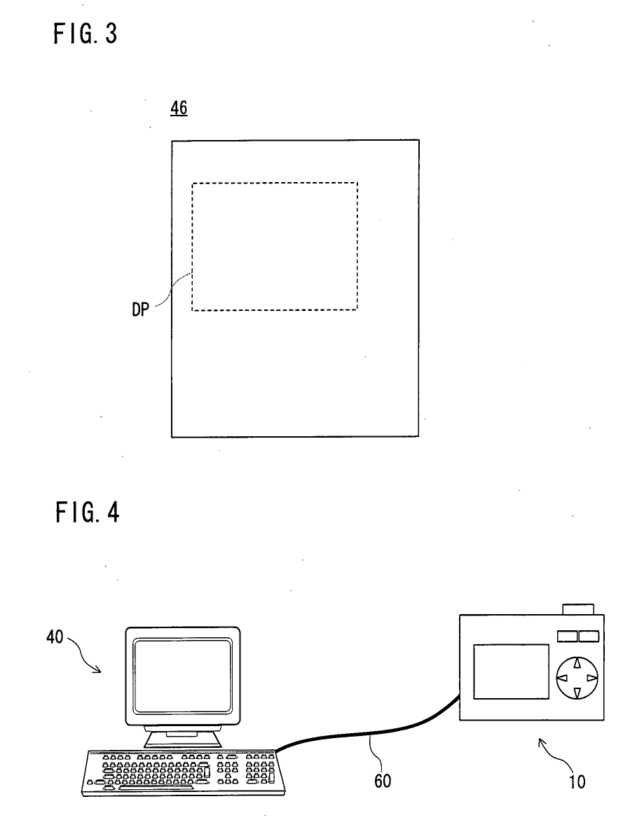

The CPU 54 assigns a display area DP to an arbitrary position on the video memory 46 in a manner shown in FIG. 3. A driver 48 reads image data belonging to the display area DP, and drives a monitor 50 on the basis of the read image data. Thus, at least a part of the image with the designated URL is displayed on the monitor screen.

When a scrolling operation is performed by the keyboard 56 and/or the mouse pointer 58, the CPU 54 moves the display area DP assigned to the video memory 46 to a desired direction. Thus, the image on the monitor screen is scrolled. When a URL changing operation is performed by the keyboard 56 and/or the mouse pointer 58, the CPU 54 changes the designation of URL. The image data with the changed URL is fetched through the communication I/F 42, and developed in the video memory 46 via the DRAM 44. The driver 48 reads the image data from the display area to thereby update the display of the monitor screen.

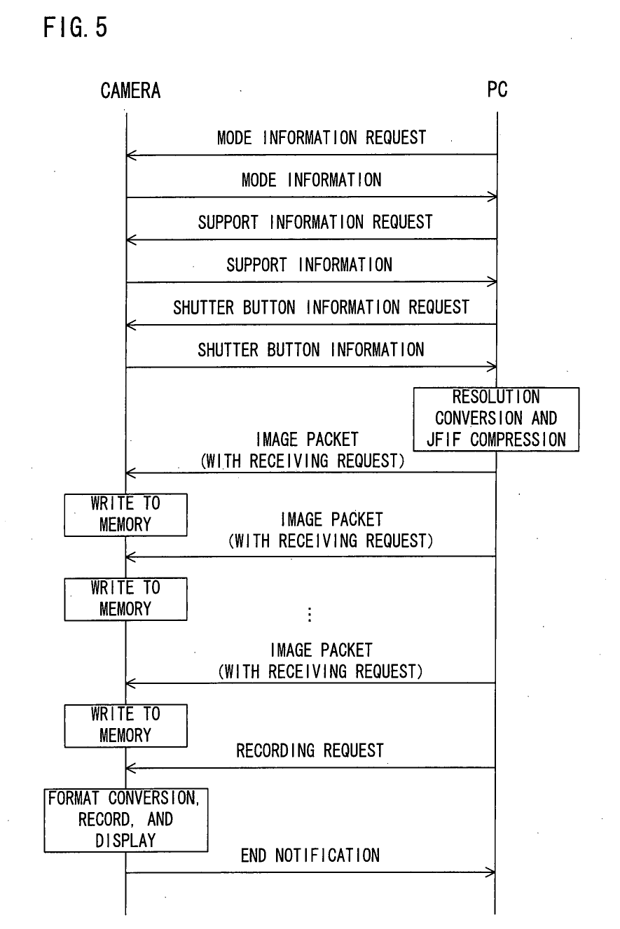

With reference to FIG. 1, FIG. 2 and FIG. 4, the digital camera 10 and the PC 40 are connected with each other by a USB cable 60. One end of the USB cable 60 is connected to a USB controller 30 of the digital camera 10, and the other end of the USB cable 60 is connected to the USB controller 52 of the PC 40. When the digital camera 10 and the PC 40 are thus connected with each other, and the digital camera 10 is set to a USB capturing mode by the mode change switch 34m, following processing is executed. Information or data is exchanged via the USB cable 60 in a manner shown in FIG. 5.

First, the PC 40 sends a mode information request to the digital camera 10 in order to inquire about a current operation mode of the digital camera 10. The digital camera 10 sends back mode information representative of “USB capturing mode” to the PC 40. The PC 40 next sends a support information request to the digital camera 10 in order to inquire a resolution (specification) supported by the digital camera 10. The digital camera 10 sends back support information describing a resolution allowing recording/reproduction processing to the PC 40.

The PC 40 successively sends a shutter button information request to the digital camera 10 in order to inquire about an operation state of the shutter button 34s. The digital camera 10 detects a current operating state of the shutter button 34s, and sends back shutter button information representative of any one of an “on state” and an “off state” to the PC 40.

When the shutter button information indicates an “on state”, the PC 40 clips image data belonging to the display area DP out of the image data developed in the video memory 46. The PC 40 further changes the resolution of the image data clipped from the video memory 46 so as to be compliant with the resolution indicated by the support information obtained from the digital camera 10. The image data having a converted resolution is stored in the DRAM 44, and compressed so as to be compliant with a JFIF format.

The PC 40 divides the compressed image data thus obtained into a plurality of image packets, and sends the divided plurality of image packets to the digital camera 10 one by one. Each image packet is embedded with a packet receiving request. The digital camera 10 receives an image packet according to a packet receiving request, and writes compressed image data included in the received image packet to the memory 18. After completion of sending all the image packets, the PC 40 sends a recording request to the digital camera 10.

The digital camera 10 converts the format of the compressed image data stored in the memory 18 from a JFIF format to an EXIF format on the memory 18. The digital camera 10 further records the EXIF file including the converted compressed image data in the memory card 28, expands the converted compressed image data by utilizing the codec 24, and displays an image on the basis of the expanded image data on the LCD monitor 22 by utilizing the LCD driver 20.

Thus, an image the same as the image displayed on the monitor 50 of the PC 40 is recorded in the memory card 28, and displayed on the LCD monitor 22.

On the above-described recording operation and displaying operation, the CPU 32 first instructs the I/F 26 to perform record processing, instructs the codec 24 to perform expansion processing, and instructs the LCD monitor 22 to perform received image displaying processing.

The I/F 26 reads the compressed image data in the EXIF format from the memory 18 through the memory control circuit 16, and records the EXIF file including the read compressed image data in the memory card 28. The codec 24 reads the compressed image data in an EXIF format from the memory card 28 through the memory control circuit 16, expands the read compressed image data, and then writes the expanded image data to the memory 18 through the memory control circuit 16. The LCD driver 20 reads the image data stored in the memory 18 through the memory control circuit 16, reduces the resolution of the read image data, and drives the LCD monitor 22 on the basis of the image data having the reduced resolution.

After completion of the recording operation and displaying operation, the digital camera 10 sends an end notification to the PC 40. The PC 40 having received the end notification outputs the above-described shutter button information request again and waits for a next operation of the shutter button 34s.

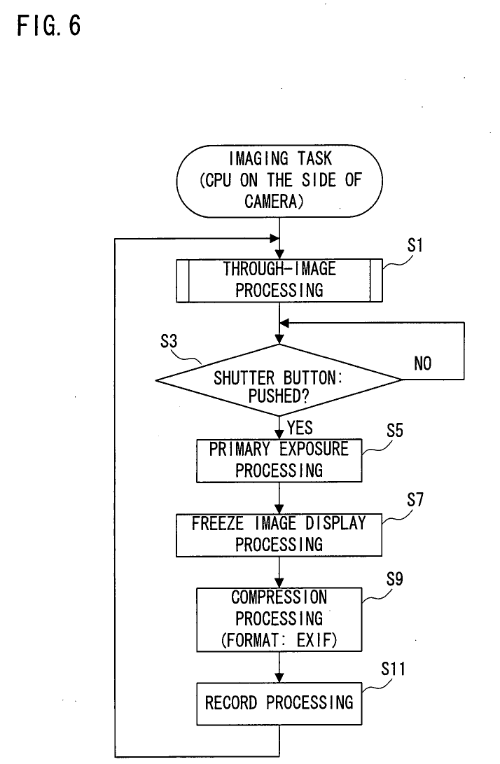

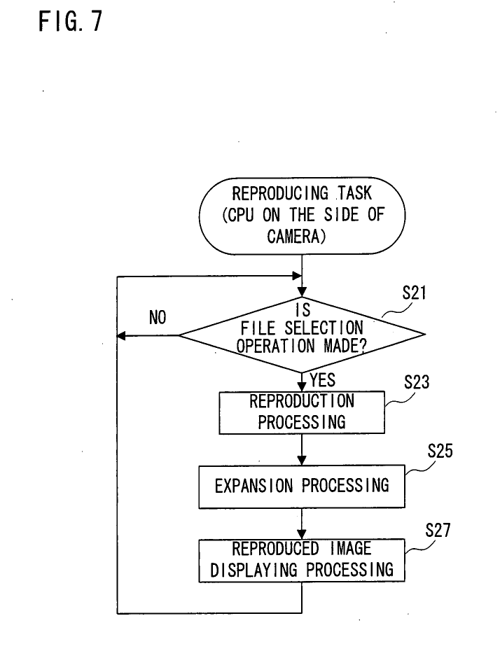

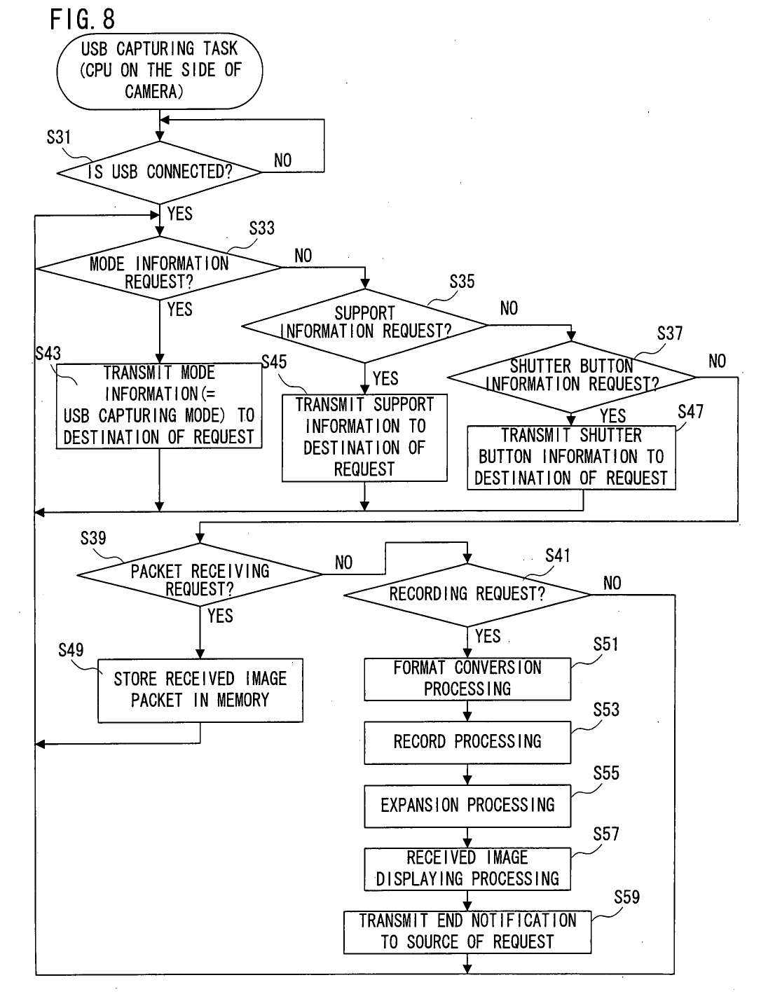

The CPU 32 of the digital camera 10 executes an imaging task shown in FIG. 6 when a camera mode is selected, a reproducing task shown in FIG. 7 when a reproduction mode is selected, and a USB capturing task shown in FIG. 8 when a USB capturing mode is selected. It should be noted that the control programs corresponding to these tasks are stored in the flash memory 36.

With reference to FIG. 6, in a step S1, in order to perform through image processing, repetition of pre-exposure processing is instructed to the imager 12, and through-image display processing is instructed to the LCD driver 20. Thus, a real-time motion image representative of an object scene is displayed on the LCD monitor 22. In a step S3, it is repeatedly determined whether or not the shutter button 34s is pushed.

If “YES” is determined here, the imager 12 is instructed to perform primary exposure processing in a step S5, the LCD driver 20 is instructed to perform freeze image displaying processing in a step S7, the codec 24 is instructed to perform compression processing in a step S9, and the I/F 26 is instructed to perform record processing in a step S11. Thus, a still image representative of an object scene at a time when the shutter button 34s is pushed is displayed on the LCD monitor 22, and an EXIF file including compressed image data corresponding to the still image is recorded in the memory card 28. After completion the process in a step S11, the process returns to the step S1.

With reference to FIG. 7, it is determined whether or not the file selection key 34f is operated in a step S21. If “YES” is determined here, reproduction processing is instructed to the I/F 26 in a step S23, expansion processing is instructed to the codec 24 in a step S25, and reproduced image displaying processing is instructed to the LCD driver 20 in a step S27. Thus, an image on the basis of the compressed image data stored in the desired EXIF file is displayed on the LCD monitor 22. After completion of the processing in the step S27, the process returns to the step S21.

With reference to FIG. 8, it is determined whether or not the USB cable 60 is connected in a step S31. If “YES” is determined here, it is determined whether or not a mode information request is received in a step S33, it is determined whether or not a support information request is received in a step S35, and it is determined whether or not a shutter button information request is received in a step S37. In addition, it is determined whether or not a packet receiving request is received in a step S39, and it is determined whether or not a recording request is received in a step S41.

When mode information is received, the process proceeds from the step S33 to a step S43 to transmit the mode information indicative of the “USB capturing mode” to the PC 40 being the source of the request. After completion of the transmission processing, the process returns to the step S33. When a support information request is received, the process proceeds from the step S35 to a step S45 to transmit the support information describing a processable resolution to the PC 40 being a source of the request. After completion of the transmission processing, the process returns to the step S33.

When a shutter button information request is received, the process proceeds from the step S37 to a step S47 to transmit shutter button information representative of a current operating state (“on state” or “off state”) of the shutter button 34s to the PC 40 being a source of the request. After completion of the transmission processing, the process returns to the step S33. When an image packet imbedded with a packet receiving request is received, the process proceeds from the step S39 to a step S49, and the compressed image data included in the received image packet is stored in the memory 18. After completion of the storing processing, the process returns to the step S33.

When a recording request is received, the process proceeds from the step S41 to a step S51, the format of the compressed image data stored in the memory 18 is converted from the JFIF format to the EXIF format. In a step S53, record processing is instructed to the I/F 26, in a step S55, expansion processing is instructed to the codec 24, and in a step S57, received image displaying processing is instructed to the LCD driver 20. Thus, an EXIF file including the compressed image data in an EXIF format is recorded in the memory card 28, and an image on the basis of the compressed image data in an EXIF format is displayed on the LCD monitor 22. After completion of the processing in the step S57, an end notification is transmitted to the PC 40 being a source of the request in a step S59, and then, the process returns to the step S33.

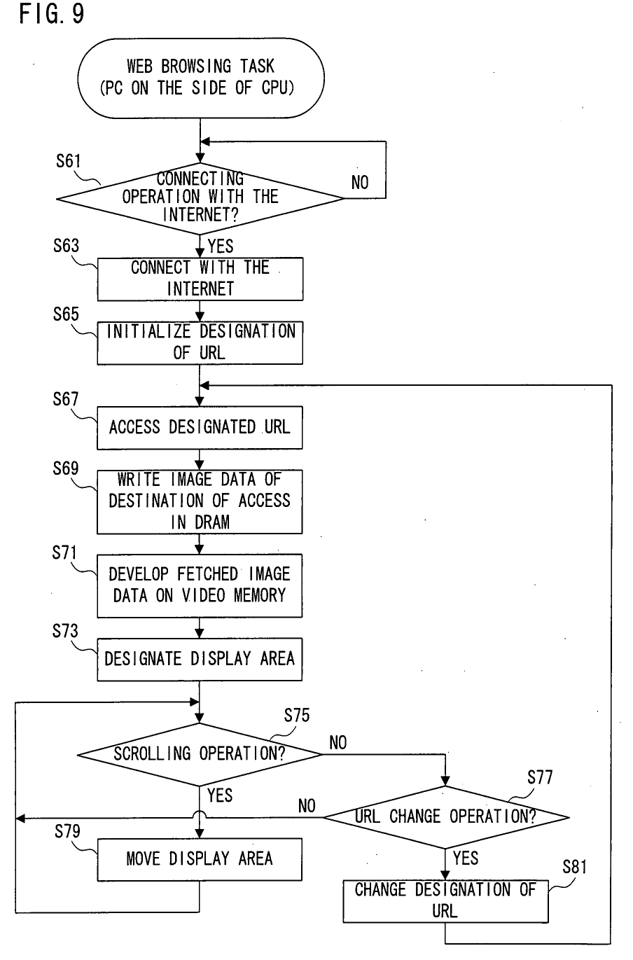

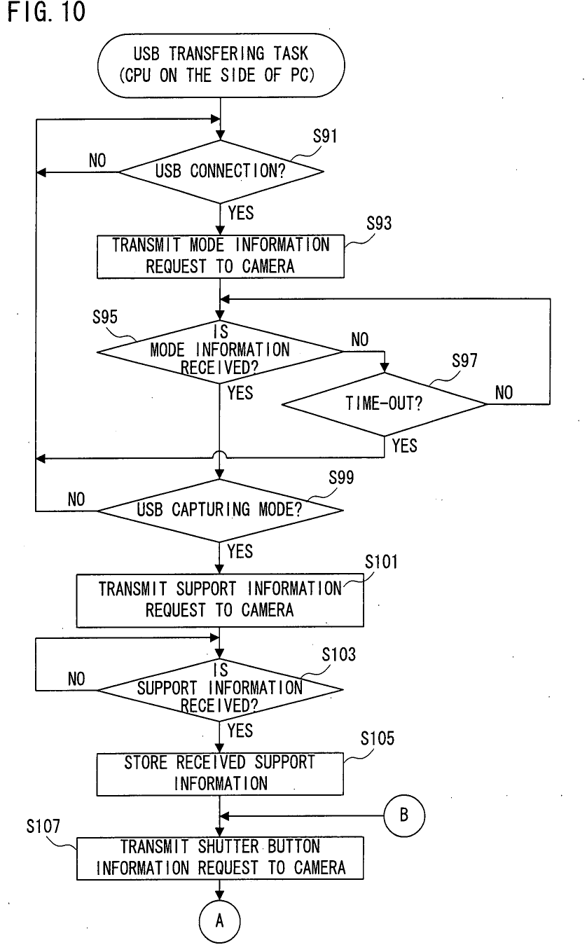

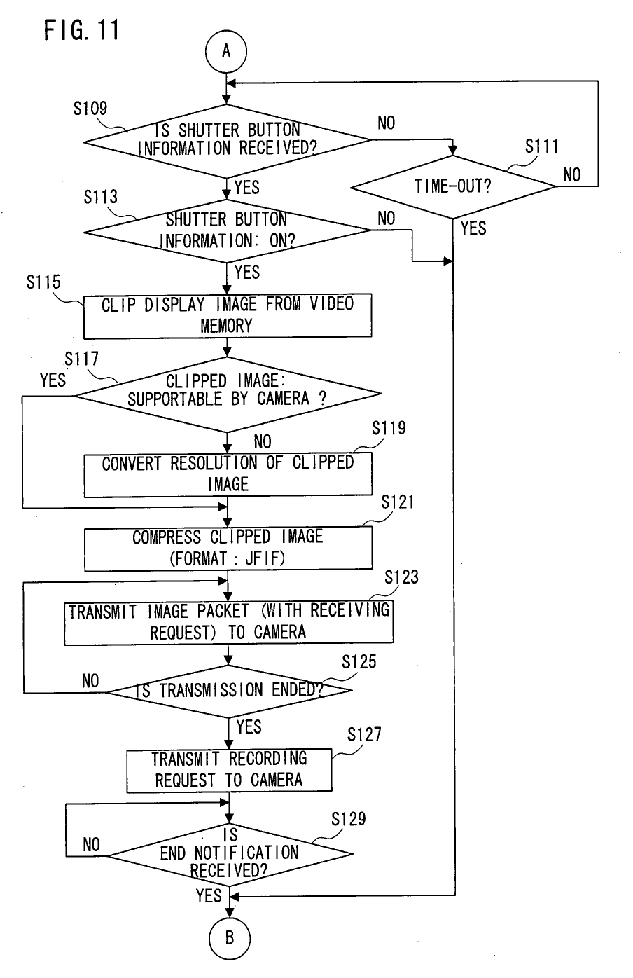

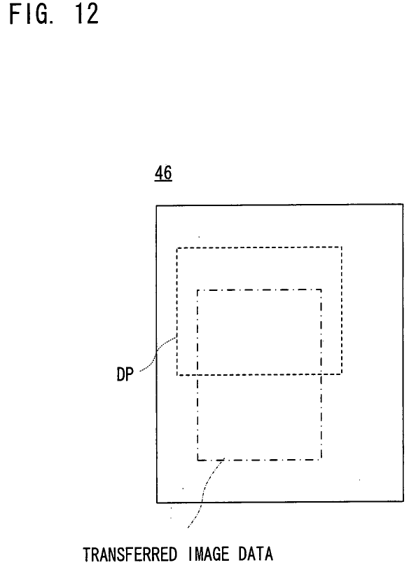

The CPU 54 of the PC 40 executes a WEB browsing task shown in FIG. 9 and a USB transferring task shown in FIG. 10-FIG. 11 in parallel with each other. It should be noted that the control programs corresponding to these tasks are stored in the hard disk 60.

With reference to FIG. 9, it is determined whether or not a connecting operation with the Internet is performed in a step S61. If “YES” is determined here, the process proceeds to a step S63 to instruct the communication I/F 42 to make a connection with the Internet. In a step S65, a designation of URL is initialized, and in a step S67, access to the designated URL is made through the communication I/F 42.

In a step S69, image data of the destination to be accessed is written to the DRAM 44, and in a step S71, the image data stored in the DRAM 44 is developed in the video memory 46. In a step S73, a display area DP (see FIG. 3) is assigned on the video memory 46. Thus, an image on the basis of the image data belonging to the display area DP is displayed on the monitor 50.

In a step S75, it is determined whether or not a scrolling operation is made, and in a step S77, it is determined whether or not a URL changing operation is performed. When a scrolling operation is performed, the process proceeds from the step S75 to a step S79 to move the display area DP to a desired direction. Thus, the image displayed on the monitor 50 is scrolled. After completion of the process in the step S79, the process returns to the step S75. When a URL changing operation is performed, the process proceeds from the step S77 to a step S81 to change the designation of the URL. After completion of the changing processing, the process returns to the step S67. Thus, the image of the changed URL is output from the monitor 50.

With reference to FIG. 10, in a step S91, it is determined whether or not the USB cable 60 is connected. If “YES” is determined here, a mode information request is transmitted to the digital camera 10 in a step S93. It is determined whether or not the mode information is received from the digital camera 10 in a step S95, and it is determined whether or not a time-out occurs in a step S97.

When a time-out occurs before reception of the mode information, the process returns from the step S97 to the step S91. On the contrary thereto, the mode information is received before occurrence of the time-out, the process proceeds from the step S95 to the step S97 to determine whether or not the mode indicated by the received mode information is a USB capturing mode. If “NO” is determined here, the process returns to the step S91 while if “YES” is determined, the process proceeds to processing in a step S101 and onward.

In the step S101, a support information request is transmitted to the digital camera 10. When support information is received from the digital camera 10, “YES” is determined in a step S103, and the received support information is stored in the DRAM 44 in a step S105. In a step S107, a shutter button information request is transmitted to the digital camera 10. In a step S109, it is determined whether or not shutter button information is received from the digital camera 10, and in a step S111, it is determined whether or not a time-out occurs.

When a time-out occurs before reception of the shutter button information, the process returns from the step S111 to the step S107. On the contrary thereto, when the shutter button information is received before occurrence of the time-out, the process proceeds from the step S109 to a step S113 to determine whether or not the state represented by the received shutter button information is an on state. If “NO” is determined here, the process returns to the step S107. On the other hand, if “YES”, the process proceeds to processing in a step S115 and onward.

In the step S115, image data belonging to the display area DP shown in FIG. 3 is clipped from the video memory 46. In a step S117, it is determined whether or not the resolution of the clipped image data is a resolution processable by the digital camera 10 on the basis of the support information stored in the DRAM 44. If “YES” is determined here, the process proceeds to a step S121 as it is while if “NO”, the resolution of the image data is converted (reduced) to a processable resolution by the digital camera 10 in a step S119, and then, the process proceeds to a step S121.

In the step S121, the image data with the resolution converted as necessary is compressed according to a JFIF format. In a step S123, the compressed image data is transmitted to the digital camera 10 in a packet format. The transmitted image packet is imbedded with a packet receiving request. In a step S125, it is determined whether or not transmission of all the image packets has been completed, and if “NO”, the process in the step S123 is repeated while if “YES”, the process proceeds to a step S127.

In the step S127, a recording request is transmitted to the digital camera 10, and in a step S129, it is determined whether or not an end notification is received from the digital camera 10. When an end notification is received, the process returns to the step S107.

As understood from the above-described explanation, an object scene is captured by the imager 12. When the shutter button 34s is operated under the control of the camera mode (first fetching mode), the CPU 32 records the image data representative of the object scene captured by the imager 12 in the memory card 28. The CPU 32 also notifies the PC (external apparatus) 40 of the support information (resolution information) describing a processable resolution under the USB capturing mode (second fetching mode) (S45). When the shutter button 34s is operated under the USB capturing mode, the shutter button information (key operation information) representative of an “on state” is output to the PC 40 (S47). The CPU 32 further inputs image data sent back from the PC 40 in response to the shutter button information representative of an “on state” (S49). The input image data is recorded in the memory card (recording medium) 28 by the CPU 32.

Accordingly, When the shutter button 34s is operated with the camera mode selected, the image data of the object scene captured by the imager 12 is recorded in the memory card 28, and when the shutter button 34s is operated with the USB capturing mode selected, the image data under the control of the PC 40 is recorded in the memory card 28. In the USB capturing mode, the support information describing the processable resolution is transferred to the PC 40, and therefore, the PC 40 can output image data being compliant with the support information to the digital camera 10. Thus, it is possible to record the image data under the control of the PC 40 in the memory card 28 in a manner similar to the imaging operation.

It is noted that although the image data belonging to the display area DP assigned on the video memory 46 is transferred from the PC 40 to the digital camera 10 in this embodiment, image data being both in and beyond the display area DP shown in FIG. 12 may be transferred from the PC 40 to the digital camera 10.

In addition, although a digital camera and a PC are connected by a wire cable such as a USB cable in this embodiment, a digital camera and a PC may be connected by radio. Furthermore, although on the assumption that a still image is transmitted from a PC to a digital camera in this embodiment, a moving image may be transmitted in place of the still image. In addition, in a case of a plurality of resolutions accommodated by a digital camera, if the resolution is converted into the highest resolution on the side of the PC, it is possible to record the image data with high image quality in the memory card.

Furthermore, although a digital camera is connected to a PC in this embodiment, a combined terminal equipped with a camera such as a mobile terminal with a camera may be connected to the PC. Furthermore, although the transfer of the image data is assumed in this embodiment, the data to be transferred is not limited to the image data, and sound data and text data may be appropriate.

In addition, although a digital camera and a PC are connected by utilizing a USB cable in this embodiment, they may be connected by means of a wireless LAN or infrared communication. Furthermore, the control program corresponding to the USB transferring task shown in FIG. 10-FIG. 11 is stored in the flash memory 36 of the digital camera 10, and transferred (automatically decompressed) to the PC when the digital camera and the PC are connected by the USB cable.

Even more, it is also appropriate that when first image data is transferred from a PC to a digital camera, a directory is created in the memory card anew, and the image data is recorded in the new directory. In this case, it is preferable that in the step S57 shown in FIG. 8, directory information is superposed on the LCD monitor.

In addition, a data fetching apparatus as an object by the data transferring program is not limited to electronic cameras furnished with an imager for capturing an object scene.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager for capturing an object scene;
a first recorder for recording image data representative of the object scene captured by said imager in a recording medium when a first fetching operation is executed under a first fetching mode;
an outputter for outputting fetching operation information to an external apparatus when a second fetching operation is executed under a second fetching mode;
an inputter for inputting image data sent back from said external apparatus in response to the fetching operation information output by said outputter; and
a second recorder for recording the image data input by said inputter in the recording medium.

2. An electronic camera according to claim 1, further comprising a resolution notifier for notifying said external apparatus of resolution information representative of a processable resolution under the second fetching mode.

3. An electronic camera according to claim 2, wherein the image data input by said inputter is image data being compliant with the resolution information notified by said resolution notifier.

4. An electronic camera according to claim 1, wherein said external apparatus comprises an image displaying apparatus, and at least a part of the image data input by said inputter represents at least a part of a display image by said image displaying apparatus.

5. An electronic camera according to claim 1 further comprising a displayer for displaying an image on the basis of the image data recorded by said second recorder.

6. An electronic camera according to claim 2, wherein said resolution notifier executes notifying processing in response to the resolution information request from said external apparatus.

7. An electronic camera according to claim 1, further comprising a mode notifier for notifying said external apparatus of mode information representative of said second fetching mode when a mode information request is received from said external apparatus under the second fetching mode.

8. An electronic camera according to claim 1, wherein the image data recorded by said first recorder adopts a specific format, and said electronic camera further comprising a converter for converting a format of the image data input by said inputter into the specific format prior to record processing by said second recorder.

9. An electronic camera according to claim 2, wherein said outputter executes output processing after notifying processing by said resolution notifier.

10. An electronic camera according to claim 1, further comprising an acceptance key for accepting the first fetching operation under the said first fetching mode and accepting the second fetching operation under the second fetching mode.

11. An image data processing program executed by a processor of an electronic camera provided with an imager for capturing an object scene, comprising:
a first record step for recording image data representative of the object scene captured by said imager in a recording medium when a first fetching operation is executed under a first fetching mode;
an output step for outputting fetching operation information to an external apparatus when a second fetching operation is executed under a second fetching mode;
an input step for inputting image data sent back from said external apparatus in response to the fetching operation information output by said output step; and
a second record step for recording the image data input by said input step in said recording medium.

12. An image data processing method executed by a processor of an electronic camera provided with an imager for capturing an object scene, comprising:
a first record step for recording image data representative of the object scene captured by said imager in a recording medium when a first fetching operation is executed under a first fetching mode;
an output step for outputting fetching operation information to an external apparatus when a second fetching operation is executed under a second fetching mode;
an input step for inputting image data sent back from said external apparatus in response to the fetching operation information output by said output step; and
a second record step for recording the image data input by said input step in said recording medium.

13. A combined program having a data fetching program executed by a processor of a data fetching apparatus and a data transferring program executed by a processor of a data transfer apparatus,
said data fetching program comprising:
a first output step for outputting fetching operation information to said data transfer apparatus when a fetching operation is executed;
a first input step for inputting data sent back from said data transfer apparatus in response to the fetching operation information output by said first output step; and
a record step for recording the data input by said first input step in a recording medium,
said data transfer program comprising:
a second input step for inputting the fetching operation information output from said data fetching apparatus; and
a second output step for outputting the data to said data fetching apparatus in response to the fetching operation information input by said second input step.

14. A combined program according to claim 13, wherein said data fetching program further comprises a specification notifying step for notifying said data transfer apparatus of specification information defining a processable specification, wherein said data transferring program further comprises a first conversion step for converting the data so as to be compliant with the specification information notified by said specification notifying step.

15. A combined program according to claim 13, wherein said data fetching program further comprises a second conversion step for converting a specification of the data input by said first input step into a specific specification prior to said record step.
